(19) United States
(12) Patent Application Publication
(10) Pub. No.: US 2007/0206771 A1
(43) Pub. Date: Sep. 6, 2007

(54) Key talk

(76) Inventor: Stephen (Steve) R. Childers, Oklahoma City, OK (US)

Correspondence Address: DUNLAP, CODDING & ROGERS P.C., PO BOX 16370, OKLAHOMA CITY, OK, 73113, US

(21) Appl. No.: 11/712,858

(22) Filed: Mar. 1, 2007

Related U.S. Application Data
(60) Provisional application No. 60/779,083, filed on Mar. 3, 2006.

(51) Int. Cl. H04M 3/00; H04M 5/00

(52) U.S. Cl. 379/265.01

(57) ABSTRACT

A system and method for providing verbal communication between at least one first communicator and at least one second communicator. The system includes a plurality of lexicons wherein at least one first lexicon is provided to the at least one first communicator. The at least one first lexicon has a plurality of words and phrases in the language of the at least one first communicator which are assigned numerical values. At least one second lexicon is provided to the at least one second communicator. The at least one second lexicon has a plurality of words and phrases in the language of the at least one second communicator which are assigned numerical values. Conversation can be provided between the at least one first communicator and the at least one second communicator by altering numbers common to both the at least one first communicator and the at least one second communicator.

### CROSS-REFERENCE TO RELATED APPLICATIONS

This application claims the benefit under 35 U.S.C. 119(e) of U.S. Provisional Application Ser. No. 60/779,083, filed Mar. 3, 2006, the contents of which are hereby expressly incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to a key talk system, and more particularly, but not by way of limitation, to an improved process of communication among individuals having the same language and different native languages.

2. Brief Description of the Related Art

Language allows people to communicate. Language often separates classes and countries of people. Sometimes language is utilized to preserve secrets. Whenever and wherever communication is restricted or restrained, isolation prevails and progress is hindered. When language is facilitated or improved, such as by the invention of the printing press, progress and social justice are enhanced. When communication is enhanced and simplified, all people benefit. Typically, with languages having a large vocabulary, there are a small number of words that are used most frequently to communicate the most basic concepts. Generally speaking, most societies have about 500 basic words that people typically use on a regular basis to communicate with one another, such as in the English language “hello”, “can”, “me”, “you”, “I”, “go”, “do”, “that” and “now”. Therefore, it is possible for people to communicate daily with about 500 basic words. People also have about 5,000 words that they less frequently utilize which articulate greater meaning in conversations. All people, regardless of their language, generally need to communicate the same basic concepts. However, due to the number of various and complex languages, it is difficult or even impossible for people who speak different languages to effectively communicate with one another without learning the other's language. Even communication between people speaking the same language can occasionally be a problem. Further, in an age where speed and productivity are essential, the more simplified and less time it takes to communicate, the more advantageous for businesses, people, and government. Therefore, what is needed is a method of communication that is more efficient than the current method of communication and which provides for a uniform means of communication among people having the same language and different native languages. It is to such a method of communication the present invention is directed.

### BRIEF DESCRIPTION OF A VIEW OF THE DRAWINGS

FIG. 1 is a schematic representation of a key talk system constructed in accordance with the present invention.

FIG. 2 is a schematic representation of another embodiment of a key talk system constructed in accordance with the present invention.

### DETAILED DESCRIPTION OF THE INVENTION

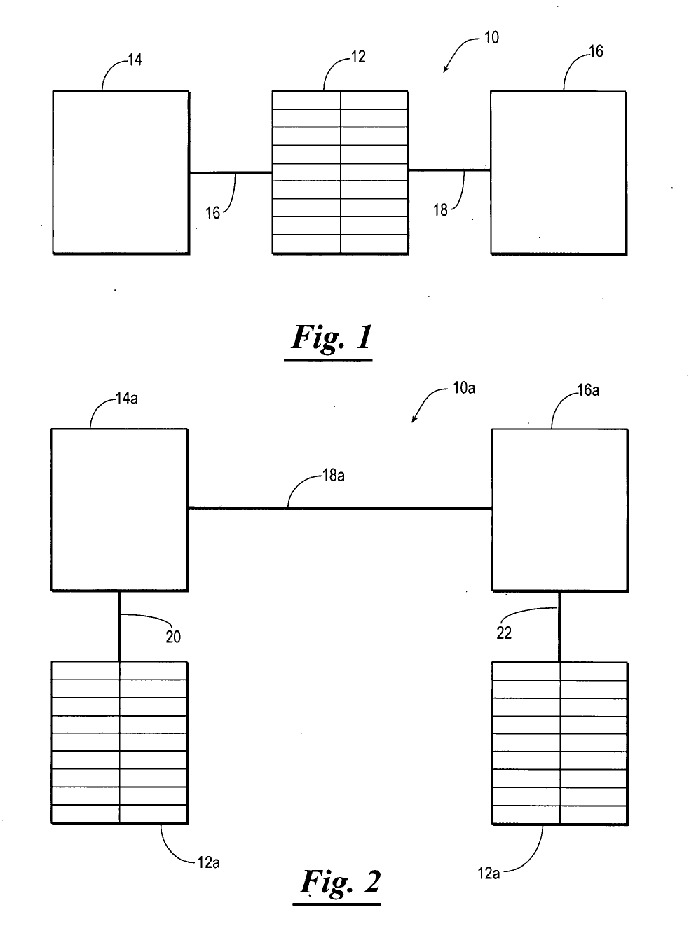

Referring now to FIG. 1, a key talk system 10 is shown constructed in accordance with the present invention. The key talk system 10 provides a method of communicating among a plurality of individuals who speak the same language or a plurality of individuals who speak different languages. In general, the key talk system 10 includes, a code lexicon 12, a first communicator 14, a second communicator 16, and a signal path 18. It should be understood that although the key talk system 10 is discussed as including the code lexicon 12, the first communicator 14, the second communicator 16, and the signal path 18, any number of communicators, code lexicons and signal paths may be utilized in the key talk system 10.

As shown in Table 1, the code lexicon 12 includes a plurality of communication codes and a plurality of words, concepts and phrases. The plurality of communication codes is represented as column 1 in Table 1. The plurality of words, concepts and phrases are represented within the plurality of horizontal rows extending between the numbers 1 and 10 in Table 1. The code lexicon 12 is organized such that an individual communication code of the plurality of communication codes is assigned to represent a corresponding word or a corresponding concept or a corresponding phrase or a corresponding combination of words, concepts and phrases of the plurality of words, concepts and phrases. Each individual communication code of the plurality of communication codes is preferably a base ten number. However, it should be understood that any base number system, such as base-2, base-4, base-5, base-6, base-8, base-12, base-16, base-20, base-24, base-32, base-60 and the like, may be utilized in accordance with the present invention.

One of the advantages of utilizing the base ten number to represent words, concepts and phrases is that most of the people of the world, regardless of their native language, already understand basic principals and fundamentals of base ten mathematics. This almost universal understanding of base ten mathematics can be harnessed to provide the structure for the key talk system 10. The individual communication code assigned to represent the corresponding word or the corresponding concept or the corresponding phrase or the corresponding combination of words, concepts and phrases is consistently assigned so as to represent an equivalent word, an equivalent concept, an equivalent phrase or an equivalent corresponding combination of words, concepts and phrases in a plurality of languages. For instance, if the base ten number “5” is assigned to represent the word “me” in English, the base ten number “5” is also assigned to represent the word “Ich” in German, “yo” in Spanish, “je” in French and so on. Therefore, whenever the first communicator 14 communicates the base ten number “5” to the second communicator 16, no matter what the native language of the first communicator 14 and no matter what the native language of the second communicator 16, both the first communicator 14 and the second communicator 16 will understand the meaning of the number “5” to be “me”.

The individual communication code can represent a single word, a plurality of words, a phrase or a concept. By way of example but not limitation, the individual communication code “2” can be designated to represent a phrase such as “how are you?” in English and the equivalent phrase “ [symbol] cómo es usted?” in Spanish and the equivalent phrase “wie geht es Ihnen?” in German and the equivalent phrase “comment allez-vous?” in French and so on for each known language.

Furthermore, the individual communication code can represent a word family. For instance, the individual communication code “3” can be designated to represent the word family: able, ability, abler, ablest, ably, abilities, unable or inability. The individual communication code can represent a concept such as “question or inquiry”. In addition, the individual communication code can represent universal time allowing one to determine a time zone; local time or military time to determine A.M. and P.M.; dates; names of individuals and places; and locations or addresses converted into Global Positioning System coordinates and latitudes and longitudes.

The code lexicon 12 can be in the physical form of printed material, such as a book, a magazine or even flash cards having a list of the plurality of words, concepts and phrases or even pictures and a list of the corresponding individual communication codes. The code lexicon 12 can be in the form of a computer program that includes the plurality of communication codes and the corresponding plurality of words, concepts and phrases stored in an electronic memory. The electronic memory can be a hard drive of a computer, a flash drive, a ram memory, a rom memory, a portable hard drive, an mp3 player, a digital telephone, a cellular phone, a dvd, a cd-rom, a magnetic tape, a local digital network system, an internet, or any other digital device or combinations and derivations thereof.

Table 1 illustrates an abbreviated example of the code lexicon 12. The plurality of communication codes of the code lexicon 12 can be divided into a plurality of numerical categories and a plurality of numerical subcategories. Each of the plurality of numerical categories can consist of a subcategory of communication codes with each of the subcategories of communication codes within that numerical category having a mathematical commonality with the other communication codes in the same numerical category. For example, a first numerical category of communication codes can have the mathematical commonality of beginning with the number “1”. A second numerical category of communication codes can have the mathematical commonality of beginning with the number “2”. A third numerical category of communication codes can have the mathematical commonality of being divisible by the number “10”. A fourth numerical category of communication codes can have the mathematical commonality of being in excess of a first predetermined number but less than a second predetermined number. A fifth numerical category of communication codes can have the mathematical commonality of ending with a predetermined number. A sixth numerical category of communication codes can have the mathematical commonality of being a non-integer.

The plurality of words, concepts and phrases of the code lexicon 12 can also be divided into word categories. By way of example but not limitation, there may be a first word category for nouns, a second word category for verbs, a third word category for prepositions, a fourth word category for adjectives, a fifth word category for adverbs and so on.

The first numerical categories of communication codes can be assigned to include all the words in the first word categories. For instance, the first numerical category of the communication codes may be assigned to represent the first word category of nouns such that all communication codes that begin with the number “1” represents some kind of noun such as “apple”. The second numerical category of communication codes may be assigned to represent the second word category of verbs, such as “go”, so that all communication codes that begin with the number “4” will represent words that are verbs. The third numerical category of communication codes may be assigned to represent the third word category of prepositions such that all communication codes that begin with the number “6” represent prepositions. The fourth numerical category of communication codes may represent the seventh word category of adjectives such as “big”. The fifth numerical category of communication codes may be base ten numbers divisible by the number “5” and may be encoded to represent a subcategory of words that are adverbs such as “quickly”. Another numerical category of communication codes may represent pronouns and so on such as “his”.

The communication code can include a category whereby a number greater than a certain number may be encoded to represent technical terms. For example, all numbers greater than 10,000 may be encoded to represent scientific or technical terms. The number 10,001 may be encoded to represent the scientific term “physics”. Furthermore, all words related to a specific scientific area can be encoded to a range of numbers. For instance, base ten numbers from 10,000 to 11,000 may represent terms or words related to the scientific disciplines. Base ten numbers with a decimal place may be encoded so as to represent a subcategory. For example, 10,001.01 may be encoded to represent the subcategory of science known as physics or, 10,001.01 may be encoded to represent the subcategory of physics such as quantum mechanics. In a similar manner, other ranges of numbers and decimal places could be encoded to represent other disciplines and subcategories of disciplines such as medicine, religion, art, entertainment, business, technology, sports or any other areas of information. Numbers beginning with a certain prefix or symbol may be encoded to represent the actual number. For example, #1,897.009 may be encoded to represent the number 1,189.009. Therefore, a quick reference to the code lexicon 12 immediately indicates the nature of the information being conveyed. The most commonly utilized words may be encoded with the lowest numbers or most memorable numbers. In other words, the ability to apply universally known mathematical structure and principals to language would allow for an easily learned global language more precise and efficient than the currently employed ad hoc plethora of languages worldwide.

TABLE 1

| Key Talk | English | German | Spanish | French |
|---|---|---|---|---|
| 1 | apple | apfel | manzana | pomme |
| 2 | how are you? | wie geht es ihnen | cómo es usted | comment allez vous |
| 3 | able | fähig | capaz | capable |
| 4 | go | gehen | vaya | allez |
| 5 | me | ich | yo | ve |
| 6 | of | von | de | de |
| 7 | big | groβ | grande | grand |
| 8 | his | siens | el suyo | sien |
| 10 | quickly | schnell | rápidamente | rapidement |
| 10,000 | scientific terms | | | |
| 10,000.1 | Physics | | | |
| 10,000.01 | quantum mechanics | | | |
| #1,897.009 | 1,897.009 | 1,897.009 | 1,897.009 | 1,897.009 |

The signal path 18 may be an acoustical signal path, a visual signal path, a wired signal path, or a wireless signal path. The signal path 18 can be logical and/or physical links and/or wireless links between various software and/or hardware utilized to implement the present invention. The physical links could be acoustic, optic fiber, copper wire, coaxial cable communication links. The signal path 18 does not have to be a single signal path but may be multiple signal paths. In addition, it should be understood that the various information does not always have to flow between the components of the present invention in the exact manner shown provided the information is generated and received to accomplish the purposes set forth herein. The communication code may be transmitted vocally, visually, electronically (either analog or digital) or via telephone, television, radio, e-mail, post, text message or by combinations and derivations thereof. For example, the communication code can be transmitted via the tone created when one of the ten numbers and two symbols on the typical key pad of a functioning telephone is depressed.

The communication code may even be recorded by any means available such that the communication code may be transmitted at a later date or time. Furthermore, key talk system 10 has the advantage of being easily communicated visually. For instance, the first communicator 14 whose native language may be English can easily visually communicate the word “apple” to a second communicator 16 whose native language may be French by simply extending one finger so as to be visible to the second communicator 16 to indicate “apple”.

In use, the first communicator 14 can utilize his voice and/or a first acoustical device, a first analog electronic device, or a first digital electronic device. For instance, the first communicator 14 can use a microphone and speaker, a walkie talkie, an analog magnetic recording device, a digital recording device, a telephone, a cellular phone, or a computer system or combinations and derivation of same. The second communicator 16 can utilize a second microphone and speaker, a second walkie talkie, a second analog magnetic recording device, a second digital recording device, a second telephone, a second cellular phone, or a second computer system or combinations and derivations of same. The first communicator 14 and the second communicator 16 are coordinated such that the first communicator 14 and the second communicator 16 are capable of receiving and transmitting via the signal path 18 acoustical, electronic, or visual information between the first communicator 14 and the second communicator 16. The first communicator 14 and the second communicator 16 are provided with the code lexicon 12. The communication code is transmitted to the second communicator 16 via the signal path 18. The second communicator 16 is provided with the code lexicon 12 for translating the communication code to the corresponding word, phrase or concept assigned to the communication code. The code lexicon 12 may then assign a communication code as a response to the first communicator 14 and transmit another communication code back to the first communicator 14 via the signal path 18. The electronic memory containing the code lexicon 12 can be integrated into the first communicator 14 and/or the second communicator 16 so as to be accessible to the first communicator 14 and the second communicator.

The communication code may also be decoded unaided by the second communicator 16. For those recipients unable to transition from the old form of communication to this method of communicating, the communication code may be decoded by an information processing system. It is anticipated that as the method of communicating becomes more and more widely accepted and utilized, there will be a lesser need for code books and information processing systems to decode the communication code. The information processing system can be, by way of example but not limitation, the internet, a network of computers, a single computer, a portable computer, a handheld electronic translator or any other device capable of decoding the number and conveying to the recipient the meaning of the number.

In order to more fully and clearly describe the present invention, the following examples are given. However, it is to be understood that the examples are for illustrative purposes and are not to be construed as limiting the invention disclosed herein.

The goal of Universal Communication (UniCom) is to promote understanding, especially between different cultures and languages, and speed the transmission and use of knowledge between all people. UniCom can break down any barriers of language between people.

Here are some examples of ways this idea might be designed and used. Please see the numbering system below.

1. Religious and Ethnic Understanding
The following faiths are paraphrased and translated into UniCom.
CHRISTIANITY
Mathew 7:12.
As you want others to do to you, do to them.
UniCom: 2 29 31 21 26 7 26 7 26 29 7 26 24
ISLAM
From the Koran: The Fourth Hadith of an-Nawawe 13.
No one of you is a believer until he loves for his brother what he loves for himself.
UniCom: 12 20 15 1 5 28 12 16 9 12 6 32 12 16 9 12.
HINDU
From the Laws of Manu
They who hurt others to gain, never find good.
Those who do not hurt others and do good find good.
UniCom: 24 34 13 21 26 10 7 18 8 11. 24 34 7 9 13 21 3 7 11 8 11.
BUDDHISM
Dana Yarga 5:18
Do not hurt others in ways that hurt you.
UniCom: 7 18 13 21 14 30 23 13 29.
CONFUCIANISM
Lun Yu Chapter 6 Vs. 28
The good person does for others what he wants them to do for him.
UniCom: 25 11 22 7 9 21 32 12 31 24 26 7 9 12.
SHINTO
Jinja Shinto
Do for others with no thought for getting.
UniCom: 7 9 21 33 17 27 9 10.
TAOISM
Tao Te Ching
Do good for others.
UniCom: 7 11 9 21.
JUDAISM
Leviticus 19:18
You are to love others as you love you.
UniCom: 29 4 26 16 21 2 29 16 21.
Other areas of use:

Business; education; law; literature; arts; politics; government; science; technology.

Because this language is made up of combinations of only 10 digits, 0-9, it can quickly and easily be learned by anyone. The following numbering system used is only an example and is not meant to be the final developed system. The final system for every day communication should be about 300 numbers with another 200 for more descriptive words.

1. a 2. as 3. and 4. are 5. believer 6. brother 7. do/does 8. find 9. for 10. get/getting 11. good 12. he/his/him/himself 13. hurt 14. in 15. is 16. love/loves 17. no 18. not 19. of 20. one 21. others 22. person 23. that 24. them/they 25. the 26. to 27. thought 28 until 29. you 30. ways 31. want/s 32. what 33. with 34. who.

Referring now to FIG. 2 is a key talk system 10a shown constructed in accordance with the present invention. In general, the key talk system 10a includes a plurality of code lexicons 12a, at least one first communicator 14a, at least one second communicator 16a, a signal path 18a, a signal path 20 and a signal path 22. The key talk system 10a provides communication between the at least one first communicator 14a and the at least one second communicator 16a. The plurality of code lexicons 12a are similar to the code lexicon 12. At least one first lexicon 12a is provided to the at least one first communicator 14a. The at least one first lexicon 12a has a plurality of words, phrases and concepts in the language of the at least one first communicator 14a which are assigned numerical values. At least one second lexicon 12a is provided to the at least one second communicator 16a. The at least one second lexicon 12a has a plurality of words, phrases and concepts in the language of the at least one second communicator 16a which are assigned numerical values, whereby conversation can be provided between the at least one first communicator 14a and the at least one second communicator 16a by altering numbers common to both the at least one first communicator and the at least one second communicator such that the at least one first communicator 14a readily communicates with the at least one second communicator 16a.

The signal path 18a may be an acoustical signal path, a visual signal path, a wired signal path or a wireless signal path. The signal path 18a can be logical and/or physical links and/or wireless links between various software and/or hardware utilized to implement the present invention. The physical links could be acoustic, optic fiber, copper wire, or coaxial cable communication links. The signal path 18a does not have to be a single signal paths but may be multiple signal paths. In addition, it should be understood that the various information does not always have to flow between the components of the present invention in the exact manner shown provided the information is generated and received to accomplish the purposes set forth herein. The communication code may be transmitted vocally, visually, electronically (either analog or digital) or via telephone, television, radio, e-mail, post, text message or by combinations and derivations thereof.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A system for providing verbal communication between at least one first communicator and at least one second communicator, the system comprising:
a plurality of lexicons wherein at least one first lexicon is provided to the at least one first communicator, the at least one first lexicon having a plurality of words and phrases in the language of the at least one first communicator which are assigned numerical values and wherein at least one second lexicon is provided to the at least one second communicator, the at least one second lexicon having a plurality of words and phrases in the language of the at least one second communicator which are assigned numerical values whereby conversation can be provided between the at least one first communicator and the at least one second communicator by altering numbers common to both the at least one first communicator and the at least one second communicator such that the at least one first communicator readily communicates with the at least one second communicator.

2. The system of claim 1 wherein the plurality of lexicons has a plurality of concepts assigned numerical values.

3. The system of claim 1 wherein the numerical values are selected from the group consisting of at least one base 10 number, at least one base 2 number, at least one base 4 number, at least one base 5 number, at least one base 6 number, at least one base 8 number, at least one base 12 number, at least one base 16 number, and at least one base 20 number.

4. The system of claim 1 wherein the numerical values are assigned to at least one name, at least one time, at least one date and at least one location.

5. The system of claim 1 wherein the at least one first communicator and the at least one second communicator have a common language.

6. The system of claim 1 wherein the at least one first communicator and the at least one second communicator have different languages.

7. A system for providing communication between at least one first communicator and at least one second communicator, the system comprising:
a plurality of lexicons wherein at least one first lexicon is provided to the at least one first communicator, the at least one first lexicon having a plurality of words and phrases in the language of the at least one first communicator which are assigned numerical values and wherein at least one second lexicon is provided to the at least one second communicator, the at least one second lexicon having a plurality of words and phrases in the language of the at least one second communicator which are assigned numerical values; and
means for transmitting the numerical values whereby communication is established between the at least one first communicator and the at least one second communicator by altering numbers common to both the at least one first communicator and the at least one second communicator such that the at least one first communicator readily communicates with the at least one second communicator.

8. The system of claim 7 wherein the plurality of lexicons has a plurality of concepts assigned numerical values.

9. The system of claim 7 wherein the numerical values are selected from the group consisting of at least one base 10 number, at least one base 2 number, at least one number is at least one base 5 number, at least one base 8 number, and at least one base 16 number.

10. The system of claim 7 wherein the numerical values are transmitted between the at least one first communicator and the at least one second communicator via electronic mail, phone, fax, numeric pager, text messaging, and wireless phone telephone.

11. The system of claim 7 wherein the numerical values are assigned to at least one name, at least one time, at least one date and at least one location.

12. The system of claim 7 wherein the at least one first communicator and the at least one second communicator have a common language.

13. The system of claim 7 wherein the at least one first communicator and the at least one second communicator have different languages.

14. A method for providing communication between at least one first communicator and at least one second communicator, comprising the steps of:
providing a plurality of lexicons wherein at least one first lexicon is provided to the at least one first communicator, the at least one first lexicon having a plurality of words and phrases in the language of the at least one first communicator which are assigned numerical values and wherein at least one second lexicon is provided to the at least one second communicator, the at least one second lexicon having a plurality of words and phrases in the language of the at least one second communicator which are assigned numerical values; and
transmitting the numerical values between the at least one communicator and the at least one second communicator whereby conversation can be provided between the at least one first communicator and the at least one second communicator by altering numbers common to both the at least one first communicator and the at least one second communicator such that the at least one first communicator readily communicates with the at least one second communicator.

15. The method of claim 14 wherein the plurality of lexicons has a plurality of concepts assigned numerical values.

16. The method of claim 14, wherein the numerical values are selected from the group consisting of at least one base 10 number, at least one base 2 number, at least one number is at least one base 5 number, at least one base 8 number, and at least one base 16 number.

17. The method of claim 14, wherein the numerical values are transmitted between the at least one first communicator and the at least one second communicator via electronic mail, phone, fax, numeric pager, text messaging, and wireless phone telephone.

18. The method of claim 14 wherein the numerical values are selected from the group consisting of at least one name, at least one time, at least one date, at least one location.

19. The method of claim 14 wherein the at least one first communicator and the at least one second communicator have a common language.

20. The method of claim 14 wherein the at least one first communicator and the at least one second communicator have different languages.
